(19) United States
(12) Patent Application Publication
(10) Pub. No.: US 2023/0202924 A1
(43) Pub. Date: Jun. 29, 2023

(54) Polyvinyl-alcohol-stabilized (meth)acrylic acid ester polymers

(71) Applicant: Wacker Chemie AG, Munich (DE)

(72) Inventors: Hans-Peter Weitzel, Reischach (DE); Ulf Dietrich, Burghausen (DE)

(73) Assignee: Wacker Chemie AG, Munich (DE)

(21) Appl. No.: 17/922,033

(22) PCT Filed: May 5, 2020
(86) PCT No.: PCT/EP2020/062412

§ 371 Date: Nov. 2, 2022

(51) Int. Cl. C04B 24/26; C08L 33/10; C04B 28/04

(52) U.S. Cl. CPC C04B 24/2641; C08L 33/10; C04B 28/04; C04B 24/2623; C08L 2201/50; C04B 2111/00637

(57) ABSTRACT

Polyvinyl alcohol-stabilized (meth)acrylic ester polymers, processes for preparing and uses for the same. Where the polyvinyl alcohol-stabilized (meth)acrylic ester polymers have particle sizes Dw of from 100 to 900 nm in the form of aqueous dispersions or water-redispersible powders. Where the (meth)acrylic ester polymers are based on
(a) 1% to 30% by weight of one or more vinyl esters of carboxylic acids having 5 to 15 carbon atoms,
(b) 20% to 80% by weight of one or more (meth)acrylic esters, wherein the homopolymer of which has a glass transition temperature Tg of ≤20° C.,
(c) 10% to 70% by weight of one or more (meth)acrylic esters, wherein the homopolymer of which has a glass transition temperature Tg of ≥50° C., and
(d) optionally one or more further ethylenically unsaturated monomers.
The percentages by weight are based on the total weight of the (meth)acrylic ester polymers.

The invention relates to polyvinyl alcohol-stabilized (meth)acrylic ester polymers in the form of aqueous dispersions or water-redispersible powders, processes for their preparation and their use in chemical products for construction such as tile adhesives, leveling compounds, powder paints or thermal insulation composite systems.

Aqueous dispersions or water-redispersible powders of polymers based on ethylenically unsaturated monomers are used in wide variety of applications, for example in adhesives, coating applications, as binder in carpet, textile and paper applications and also in chemical products for construction such as tile adhesives, renders and sealing compounds. Such polymer dispersions are typically prepared by aqueous emulsion polymerization of ethylenically unsaturated monomers, for example batchwise (discontinuously) in stirred polymerization reactors or else continuously, for example in stirred tank cascades. Dispersion powders can be prepared by spray drying aqueous polymer dispersions with the addition of drying aids, such as polyvinyl alcohol, as described for example in DE-A 2049114. Readily free-flowing powders thus obtainable having particle sizes of between 10 and 250 μm can be redispersed in water again to form dispersions having particle sizes of between 0.1 and 5 μm. Such redispersions, in order to be usable in the above-mentioned applications, must remain stable over a relatively long period of time, that is to say they must not have a tendency to sediment.

Aqueous polymer dispersions are typically stabilized with protective colloids, such as polyvinyl alcohol, or emulsifiers of diverse chemistry. In the case of vinyl acetate copolymers, polyvinyl alcohol is often used as protective colloid in order to obtain both stable polymer dispersions and also redispersible dispersion powders having the desired powder properties. In contrast, in the case of conventional (meth)acrylic ester copolymers, stabilization with customary polyvinyl alcohols has not proven successful since such dispersions are not sufficiently stable or frequently form coarse polymer particles, which should be prevented.

In order to avoid such problems in the case of (meth)acrylic ester copolymers, emulsifiers have in many cases been used as stabilizers. However, emulsifiers can be problematic from ecological or health viewpoints, for example because of their irritating or sensitizing action, meaning that corresponding end products containing emulsifiers can adversely affect users or even require labeling as hazardous substance. There is therefore a desire to dispense with emulsifiers as stabilizers.

As protective colloids for stabilizing (meth)acrylic ester polymers, highly specific, modified polyvinyl alcohols have to date been used. For instance, JP2004 339291, JP2004323571, JP2004331785, JP07070989 and JP05059106 describe mercapto-functional polyvinyl alcohols for this. WO2006095524 teaches polyvinyl alcohols having a defined proportion of 1,2-glycol groups. It was possible with the specific synthesis strategies of DE19928933 to obtain stable, but only coarse, (meth)acrylic ester polymer dispersions. Such specific, modified polyvinyl alcohols are firstly complex to prepare and expensive. In addition, such functional groups introduced into polyvinyl alcohol can have a negative impact on the processability or other properties of the application products.

Against this background, an object was that of providing finely divided, stable, protective colloid-stabilized aqueous dispersions of (meth)acrylic ester polymers and also corresponding water redispersible powders, where the protective colloids used should as far as possible be conventional unmodified polyvinyl alcohols. Furthermore, such aqueous dispersions or water-redispersible powders should be obtainable using established methods that are as simple as possible.

The invention provides polyvinyl alcohol-stabilized (meth)acrylic ester polymers having particle sizes Dw of from 100 to 900 nm in the form of aqueous dispersions or water-redispersible powders, characterized in that the (meth)acrylic ester polymers are based on
a) 1% to 30% by weight of one or more vinyl esters of carboxylic acids having 5 to 15 carbon atoms,
b) 20% to 80% by weight of one or more (meth)acrylic esters, the homopolymer of which has a glass transition temperature Tg of ≤20° C.,
c) 10% to 70% by weight of one or more (meth)acrylic esters, the homopolymer of which has a glass transition temperature Tg of ≥50° C., and
   optionally one or more further ethylenically unsaturated monomers,
   where the percentages by weight are based on the total weight of the (meth)acrylic ester polymers.

(Meth)acrylic ester polymers generally encompass acrylic ester polymers or methacrylic ester polymers and preferably copolymers of acrylic esters and methacrylic esters. (Meth)acrylic esters generally denote acrylic esters and methacrylic esters.

Preferred vinyl esters a) are vinyl esters of carboxylic acids having 9 to 12 carbon atoms.

Examples of vinyl esters a) are vinyl 2-ethylhexanoate, vinyl laurate, vinyl pivalate and vinyl esters of alpha-branched monocarboxylic acids having 5 to 13 carbon atoms, such as VeoVa9R, VeoVa10R, VeoVa11R or VeoVa12R (trade names from Hexion). Preference is given to vinyl esters of alpha-branched monocarboxylic acids having 9 to 13 carbon atoms and in particular vinyl laurate.

The (meth)acrylic ester polymers are preferably based to an extent of 3% to 25% by weight, particularly preferably 5% to 20% by weight and most preferably 10% to 15% by weight, on vinyl ester a), based on the total weight of the (meth)acrylic ester polymers.

Preference is given to (meth)acrylic esters b), the homopolymers of which have a glass transition temperature Tg of ≤10° C.

(Meth)acrylic esters b) can, for example, be (meth)acrylic esters of linear or branched C₁ to C₁₈ alkanols, in particular C₁ to C₁₅ alkanols. Examples of such alkanols are n-propyl, n-butyl, isobutyl, n-pentyl, n-hexyl, n-nonyl or n-decyl alkanols.

Preferred (meth)acrylic esters b) are n-butyl acrylate, n-hexyl acrylate, n-hexyl methacrylate, 2-ethylhexyl acrylate, 2-ethylhexyl methacrylate, lauryl acrylate and stearyl acrylate. Most preferred is butyl acrylate, especially n-butyl acrylate.

The (meth)acrylic ester polymers are preferably based to an extent of 25% to 70% by weight, particularly preferably 30% to 65% by weight and most preferably 40% to 60% by weight, on (meth)acrylic esters b), based on the total weight of the (meth)acrylic ester polymers.

Preference is given to (meth)acrylic esters c), the homopolymers of which have a glass transition temperature Tg of ≥60° C., in particular ≥80° C.

(Meth)acrylic esters c) can, for example, be (meth)acrylic esters of linear or branched C₁ to C₁₀ alkanols, in particular C₁ to C₁₀ alkanols.

Preferred (meth)acrylic esters c) are methyl methacrylate, tert-butyl methacrylate and tert-butyl acrylate. Particular preference is given to methyl methacrylate.

The (meth)acrylic ester polymers are preferably based to an extent of 15% to 60% by weight, particularly preferably 20% to 55% by weight and most preferably 25% to 50% by weight, on (meth)acrylic esters c), based on the total weight of the (meth)acrylic ester polymers.

The (meth)acrylic ester polymers are preferably based to an extent of 50% to 99% by weight, particularly preferably 65% to 97% by weight and most preferably 80% to 95% by weight, on (meth)acrylic esters b) and (meth)acrylic esters c), based in each case on the total weight of the (meth)acrylic ester polymers.

The further monomers generally differ from monomers a) to c).

Examples of further monomers include ethylenically unsaturated silanes d), such as compounds of the general formula R¹SiR²₀₋₂(OR³)₁₋₃, where R² is a C₁ to C₃ alkyl radical, C₁ to C₃ alkoxy radical or halogen, for example chlorine or bromine, R¹ denotes CH₂═CR⁴—(CH₂)₀₋₁ or CH₂═CR⁴CO₂(CH₂)₁₋₃ with R⁴ as a carbon radical having 1 to 10 carbon atoms, R³ is an unbranched or branched, optionally substituted alkyl radical having 1 to 12 carbon atoms, preferably 1 to 3 carbon atoms. As is known, the silicon atom Si is tetravalent.

Preference is given to γ-acryl- and γ-methacryloxypropyltri(alkoxy)silanes, α-methacryloxymethyltri(alkoxy)silanes, γ-methacryloxypropylmethyldi(alkoxy)silanes, vinylalkyldi(alkoxy)silanes and vinyltri(alkoxy)silanes, with examples of alkoxy groups that may be used including methoxy, ethoxy, isopropoxy, methoxyethylene, ethoxyethylene, methoxypropylene glycol ether and ethoxypropylene glycol ether radicals.

Particular preference is given to vinyltrimethoxysilane, vinylmethyldimethoxysilane, vinyltriethoxysilane, vinylmethyldiethoxysilane, vinyltripropoxysilane, vinyltriisopropoxysilane, vinyltris(1-methoxy)isopropoxysilane, vinyltributoxysilane, 3-methacryloxypropyltrimethoxysilane, 3-methacryloxypropylmethyldimethoxysilane, methacryloxymethyltrimethoxysilane, 3-methacryloxypropyltris(2-methoxyethoxy)silane, vinyltris(2-methoxyethoxy)silane, allylvinyltrimethoxysilane, allyltrimethoxysilane, vinyldimethylmethoxysilane, vinyldimethylethoxysilane, vinylisobutyldimethoxysilane, vinyltriisopropyloxysilane, vinyltributoxysilane, vinyltrihexyloxysilane, vinylmethoxydihexyloxysilane, vinyltrioctyloxysilane, vinyldimethoxyoctyloxysilane, vinylmethoxydioctyloxysilane, vinylmethoxydilauryloxysilane and vinyldimethoxylauryloxysilane. Most preferred are vinyltrimethoxysilane, vinylmethyldimethoxysilane, vinyltriethoxysilane, vinyltriisopropoxysilane, vinylmethyldiethoxysilane, vinyltris(1-methoxy)isopropoxysilane, methacryloxypropyltris(2-methoxyethoxy)silane, 3-methacryloxypropyltrimethoxysilane, 3-methacryloxypropylmethyldimethoxysilane and methacryloxymethyltrimethoxysilane. Preference is given to vinylsilanes, i.e. silanes containing vinyl groups.

The (meth)acrylic ester polymers are based to an extent of preferably 0% to 5% by weight, particularly preferably 0.1% to 3% by weight and most preferably 0.5% to 1% by weight, on ethylenically unsaturated silanes d), based on the total weight of the (meth)acrylic ester polymers.

Further monomers are, for example, epoxy-functional, ethylenically unsaturated monomers e), in particular glycidyl methacrylate and glycidyl acrylate.

The (meth)acrylic ester polymers are based to an extent of preferably 0% to 5% by weight, particularly preferably 0.1% to 3% by weight and most preferably 0.5% to 2% by weight, on monomers e), based on the total weight of the (meth)acrylic ester polymers.

Examples of further monomers also include one or more ethylenically unsaturated monomers f) selected from the group comprising vinyl esters of carboxylic acids having 2 to 4 carbon atoms, olefins, dienes, vinylaromatics and vinyl halides.

Examples of vinyl esters f) are vinyl propionate, vinyl butyrate, 1-methylvinyl acetate and in particular vinyl acetate. Preferred olefins or dienes are ethylene, propylene, and 1,3-butadiene. Preferred vinylaromatics are styrene and vinyltoluene. A preferred vinyl halide is vinyl chloride.

Monomers f), in particular vinyl esters of carboxylic acids having 2 to 4 carbon atoms and/or ethylene, are incorporated by polymerization into the (meth)acrylic ester polymers to an extent of preferably 0 to 20% by weight and particularly preferably 0.1% to 10% by weight, based on the total weight of the (meth)acrylic ester polymers. Most preferably, the (meth)acrylic ester polymers contain no monomer unit f), in particular no vinyl ester unit f) and/or no ethylene unit.

The further monomers optionally also comprise 0 to 20% by weight, preferably 0.5% to 10% by weight, based on the total weight of the (meth)acrylic ester polymers, of one or more auxiliary monomers g). Examples of auxiliary monomers g) are ethylenically unsaturated mono- and dicarboxylic acids, preferably acrylic acid, methacrylic acid, fumaric acid and maleic acid; ethylenically unsaturated carboxamides and carbonitriles, preferably acrylamide and acrylonitrile; mono- and diesters of fumaric acid and maleic acid, such as the diethyl and diisopropyl esters, and also maleic anhydride, ethylenically unsaturated sulfonic acids or salts thereof, preferably vinylsulfonic acid, and 2-acrylamido-2-methylpropanesulfonic acid. Further examples are pre-crosslinking comonomers such as multiply ethylenically unsaturated comonomers, for example divinyl adipate, diallyl maleate, allyl methacrylate or triallyl cyanurate, or post-crosslinking comonomers, for example acrylamidoglycolic acid (AGA), methyl methylacrylamidoglycolate (MMAG), N-methylolacrylamide (NMA), N-methylolmethacrylamide (NMMA), N-methylol allyl carbamate, alkyl ethers such as the isobutoxy ether or ester of N-methylol acrylamide, of N-methylol methacrylamide, and of N-methylol allyl carbamate. Mention may also be made of monomers comprising hydroxy or CO groups, for example hydroxyalkyl methacrylates and acrylates, such as hydroxyethyl, hydroxypropyl or hydroxybutyl acrylate or methacrylate, and also compounds such as diacetone acrylamide and acetylacetoxyethyl acrylate or methacrylate Further examples also include vinyl ethers such as methyl, ethyl, or isobutyl vinyl ether.

The (meth)acrylic ester polymers preferably contain no carboxamide unit g), in particular no acrylamide unit. Particularly preferably, the (meth)acrylic ester polymers contain no unit from monomers of the group comprising acrylamidoglycolic acid (AGA), methylacrylamidoglycolic acid methyl ester (MAGME), N-methylolacrylamide (NMA), N-methylolmethacrylamide (NMMA), N-methylolallyl carbamate, alkyl ethers such as the isobutoxy ether or ester of N-methylolacrylamide, of N-methylolmethacrylamide and of N-methylolallyl carbamate.

Preferred further monomers are ethylenically unsaturated silanes d) and epoxy-functional, ethylenically unsaturated monomers e).

Further monomers are incorporated by polymerization into the (meth)acrylic ester polymers to an extent of preferably 0% to 20% by weight, particularly preferably 0.1% to 10% by weight and most preferably 1% to 5% by weight, based on the total weight of the (meth)acrylic ester polymers.

The (meth)acrylic ester polymers have weight-average particle diameters Dw of between 100 nm and 900 nm, preferably 200 nm to 800 nm and particularly preferably between 250 nm and 800 nm.

The polydispersity PD of the (meth)acrylic ester polymers is preferably ≤3, particularly preferably ≤2.5 and most preferably ≤2. The polydispersity PD is the ratio of weight-average particle diameter Dw to number-average particle diameter Dn; PD=Dw/Dn.

The parameters Dw and Dn, or the particle size distribution, are determined by means of laser light diffraction and laser light scattering on the basis of the (meth)acrylic ester polymers using an LS13320 measuring instrument with the optical model PVAC.RF780D, including PIDS, from Beckmann-Coulter, and in observation of the device manufacturer's instructions, after sufficient dilution of the aqueous polymer dispersions with deionized water.

The selection of monomers or the selection of the proportions by weight of the comonomers is carried out in such a way as to result, for the (meth)acrylic ester polymers, in glass transition temperatures Tg in general of ≤+120° C., preferably −50° C. to +60° C., more preferably still −30° C. to +40° C. and most preferably −15° C. to +20° C.

The glass transition temperature Tg can be determined in a known manner by differential scanning calorimetry (DSC). An approximate Tg can also be precalculated by means of the Fox equation. According to Fox T. G., Bull. Am. Physics Soc. 1, 3, page 123 (1956): 1/Tg=x₁/Tg₁+x₂/Tg₂+ . . . +xₙ/Tgₙ, where xₙ is the mass fraction (% by weight/100) of the monomer n, and Tgₙ is the glass transition temperature in Kelvin of the homopolymer of the monomer n. Tg values for homopolymers are listed in Polymer Handbook 2nd Edition, J. Wiley & Sons, New York (1975).

The polyvinyl alcohols may for example be partially hydrolyzed or fully hydrolyzed polyvinyl alcohols, for example with a degree of hydrolysis of from 80 to 100 mol %, particularly preferably partially hydrolyzed polyvinyl alcohols with a degree of hydrolysis of from 80 to 95 mol %, in particular 86 to 90 mol %. The Hoppler viscosity of the polyvinyl alcohols, in a 4% aqueous solution, is preferably 1 to 30 mPas, particularly preferably 2 to 20 mPas and most preferably 3 to 15 mPas (Hoppler method at 20° C., DIN 53015).

Polyvinyl alcohols are present in an amount of preferably 1% to 30% by weight, particularly preferably 3% to 20% by weight and most preferably 5% to 15% by weight, based on the total weight of the (meth)acrylic ester polymers.

Preference is also given to partially hydrolyzed, hydrophobically modified polyvinyl alcohols, in particular partially hydrolyzed, hydrophobically modified polyvinyl alcohols with a degree of hydrolysis of 80 to 95 mol %, in particular with a Hoppler viscosity, in a 4% aqueous solution, of 1 to 30 mPas. Examples of these include partially hydrolyzed copolymers of vinyl acetate with hydrophobic comonomers such as isopropenyl acetate, vinyl pivalate, vinyl ethylhexanoate, vinyl esters of saturated alpha-branched monocarboxylic acids having 5 or 9 to 11 carbon atoms, dialkyl maleates and dialkyl fumarates such as diisopropyl maleate and diisopropyl fumarate, vinyl chloride, vinyl alkyl ethers such as vinyl butyl ether, olefins such as ethene and decene. The proportion of the hydrophobic units is preferably 0.1% to 10% by weight, based on the total weight of the partially hydrolyzed polyvinyl alcohol. Mixtures of the polyvinyl alcohols mentioned may also be used. Particularly preferably, no hydrophobically modified polyvinyl alcohols are present.

The polyvinyl alcohols preferably contain no mercapto groups and/or no 1,2-glycol groups. The polyvinyl alcohols consist to an extent of preferably ≥80% by weight, more preferably ≥90% by weight and particularly preferably ≥95% by weight of vinyl alcohol and vinyl acetate units, based on the total weight of the polyvinyl alcohols. Most preferably, the polyvinyl alcohols consist exclusively of vinyl alcohol and vinyl acetate units.

Besides polyvinyl alcohol, one or more further protective colloids may additionally be present, such as for example polyvinyl acetals; polyvinylpyrrolidones; polysaccharides in water-soluble form, such as starches (amylose and amylopectin), celluloses and the carboxymethyl, methyl, hydroxyethyl, and hydroxypropyl derivatives thereof, dextrins and cyclodextrins; proteins such as casein or caseinate, soy protein, gelatin; lignosulfonates; synthetic polymers such as poly(meth)acrylic acid, copolymers of (meth)acrylates with carboxy-functional comonomer units, poly(meth)acrylamide, polyvinylsulfonic acids and the water-soluble copolymers thereof; melamine-formaldehyde sulfonates, naphthalene-formaldehyde sulfonates, styrene-maleic acid copolymers and vinyl ether-maleic acid copolymers.

The further protective colloids may be present, for example, in an amount of 0 to 20% by weight, in particular 0.1% to 10% by weight. Further protective colloids are preferably present to an extent of ≤20% by weight, particularly preferably ≤10% by weight. The percentages by weight are based on the total weight of the (meth)acrylic ester polymers. Most preferably, no further protective colloids are present. Preferably, exclusively polyvinyl alcohols are present as protective colloids.

The polyvinyl alcohols and protective colloids mentioned are obtainable by means of processes known to those skilled in the art or are commercially available.

One or more emulsifiers may also optionally be present, such as anionic, cationic or nonionic emulsifiers, especially anionic surfactants such as alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl- or alkylarylsulfonates having 8 to 18 carbon atoms, esters and monoesters of sulfosuccinic acid with monohydric alcohols or alkylphenols, or nonionic surfactants such as alkyl polyglycol ethers or alkylaryl polyglycol ethers having 8 to 40 ethylene oxide units.

Emulsifiers can be present in an amount of, for example, 0 to 10% by weight, in particular 0.1% to 5% by weight, based on the total weight of the (meth)acrylic ester polymers. Particularly preferably, no emulsifiers are present.

The invention further provides processes for preparing polyvinyl alcohol-stabilized (meth)acrylic ester polymers having particle sizes Dw of from 100 to 900 nm in the form of aqueous dispersions or water-redispersible powders by means of free-radically initiated emulsion polymerization of ethylenically unsaturated monomers in the presence of polyvinyl alcohol in aqueous medium and optionally subsequent drying, characterized in that
a) 1% to 30% by weight of one or more vinyl esters of carboxylic acids having 5 to 15 carbon atoms,
b) 20% to 80% by weight of one or more (meth)acrylic esters, the homopolymer of which has a glass transition temperature Tg of ≤20° C.,
c) 10% to 70% by weight of one or more (meth)acrylic esters, the homopolymer of which has a glass transition temperature Tg of ≥50° C., and
   optionally one or more further ethylenically unsaturated monomers are polymerized, where the percentages by weight are based on the total weight of the (meth)acrylic ester polymers.

The polymerization temperature is generally 40° C. to 150° C., preferably 60° C. to 90° C.

The polymerization can be initiated using the redox initiator combinations commonly used for emulsion polymerization. Examples of suitable oxidation initiators include the sodium, potassium and ammonium salts of peroxodisulfuric acid, hydrogen peroxide, t-butyl peroxide, t-butyl hydroperoxide, potassium peroxodiphosphate, t-butyl peroxopivalate, cumene hydroperoxide, isopropylbenzene monohydroperoxide, azobisisobutyronitrile. Preference is given to the sodium, potassium and ammonium salts of peroxodisulfuric acid, and hydrogen peroxide. The initiators mentioned are generally used in an amount of 0.01% to 2.0% by weight, based on the total weight of the ethylenically unsaturated monomers.

Suitable reducing agents are, for example, the sulfites and bisulfites of alkali metals and ammonium, such as sodium sulfite, the derivatives of sulfoxylic acid such as zinc or alkali metal formaldehyde sulfoxylates, for example sodium hydroxymethanesulfinate (Bruggolite) and (iso)ascorbic acid. Sodium hydroxymethanesulfinate and (iso)ascorbic acid are preferred. The amount of reducing agent is preferably 0.015% to 3% by weight, based on the total weight of the ethylenically unsaturated monomers.

The oxidizing agents mentioned, in particular the salts of peroxodisulfuric acid, can also be used alone as thermal initiators.

Substances that act as chain transfer agents can be used during the polymerization to control the molecular weight. If chain transfer agents are used, they are typically used in amounts of between 0.01% to 5.0% by weight, based on the monomers to be polymerized, and are added separately or else premixed with the reaction components. Examples of such substances are n-dodecyl mercaptan, tert-dodecyl mercaptan, mercaptopropionic acid, methyl mercaptopropionate, isopropanol and acetaldehyde. Preferably, no substances that act as chain transfer agents are used.

To stabilize the polymerization mixture, polyvinyl alcohol is added in the emulsion polymerization in an amount of preferably in total 1% to 20% by weight, based on the total weight of the ethylenically unsaturated monomers.

It is possible in the emulsion polymerization to operate according to batchwise processes in which all components of the polymerization mixture are initially charged in the reactor, or according to semi-batchwise processes in which individual or multiple components are initially charged and the remainder are metered in, or a continuous polymerization can be conducted in which the components are metered in during the polymerization. The metered additions can optionally be performed (spatially and temporally) separately.

Preferably, vinyl ester a) is initially charged in part or, in particular, in full. The (meth)acrylic esters b) and/or the (meth)acrylic esters c) and optionally the further ethylenically unsaturated monomers are preferably metered in in full or in part. Particularly preferably, the total amount of vinyl ester a) used is initially charged or metered in before the (meth)acrylic esters b) and/or the (meth)acrylic esters c) and optionally the further monomers are metered in. Most preferably, the vinyl esters a) are partly or, in particular, fully polymerized to completion before the (meth)acrylic esters b) and/or the (meth)acrylic esters c) and optionally the further monomers are metered in. Preference is given to polymerizing all monomers in the same reactor. Alternatively, it is also possible to use a polymer based on the vinyl esters a) in the form of an aqueous dispersion as a seed, and to polymerize the (meth)acrylic esters b) and/or the (meth)acrylic esters c) and optionally the further monomers in the presence of the seed. The seed may be initially charged in part or in full, or metered in in part or in full. Preference is given to initially charging the seed in full.

On conclusion of the emulsion polymerization, residual monomers can be removed by postpolymerization using known methods, for example by redox catalyst-initiated postpolymerization. Volatile residual monomers can also be removed by means of distillation, preferably under reduced pressure, and optionally while passing inert entraining gases through or over the mixture, such as air, nitrogen or water vapor.

The (meth)acrylic ester polymers are generally obtained in the form of polyvinyl alcohol-stabilized aqueous dispersions. The aqueous dispersions have a solids content of preferably 30% to 75% by weight, and particularly preferably 40% to 65% by weight.

For preparation of the (meth)acrylic ester polymers in the form of water-redispersible powders, the aqueous dispersions, optionally after addition of protective colloids, for example polyvinyl alcohol, especially the polyvinyl alcohol described above, as drying aid, can be dried, for example by means of fluidized bed drying, freeze drying or spray drying. Preference is given to spray drying the dispersions. The spray drying can be conducted in standard spray drying systems, in which case the atomization can be effected, for example, by means of one-, two- or multiphase nozzles or with a rotating disk. The exit temperature is generally chosen within the range from 45° C. to 120° C., preferably 60° C. to 90° C., according to the system, Tg of the resin and desired degree of drying.

In general, the drying aid is used in a total amount of 3% to 30% by weight, based on the polymeric constituents of the dispersion. The total amount of protective colloid, especially polyvinyl alcohol, prior to the drying operation is preferably 3% to 30% by weight, particularly preferably 5% to 20% by weight, based on the polymer content. Examples of suitable drying aids are the abovementioned protective colloids, especially polyvinyl alcohols, preferably the polyvinyl alcohols described above. Preference is given to using no further protective colloids other than polyvinyl alcohols as drying aid.

In the atomization, it has in many cases been found to be favorable to add an antifoam, preferably up to 3% by weight of antifoam, based on the total weight of the (meth)acrylic ester polymers. To increase storability by improving the blocking stability, the powder obtained can be provided with an antiblocking agent (anticaking agent), preferably up to 30% by weight, based on the total weight of polymeric constituents. Examples of antiblocking agents are calcium carbonate or magnesium carbonate, talc, gypsum, silica, especially hydrophobic silica, kaolins, silicates having particle sizes preferably in the range from 10 nm to 10 μm.

The viscosity of the feed to be atomized is adjusted by the solids content preferably so as to obtain a value of

<500 mPas (Brookfield viscosity at 20 revolutions and 23° C.), especially preferably <250 mPas. The solids content of the dispersion to be atomized is preferably >35%, especially preferably >40%.

To improve the performance properties, it is possible to add further additives, for example in the atomization. Further constituents of redispersible polymer powder compositions that are present in preferred embodiments are pigments, fillers, foam stabilizers, hydrophobizing agents.

The polyvinyl alcohol-stabilized (meth)acrylic ester polymers according to the invention are suitable in particular for use in chemical products for construction. They can be used alone or in combination with conventional polymer dispersions or dispersion powders, optionally in conjunction with hydraulically setting binders such as cements (portland cement, aluminate cement, trass cement, slag cement, magnesia cement, phosphate cement) gypsum and waterglass for the production of leveling compounds, construction adhesives, renders, spackling compounds, jointing mortars, sealing slurries, thermal insulation composite systems or paints, for example powder paints. Among construction adhesives, tile adhesives or integrated thermal insulation adhesives are preferred areas of use for the dispersion powder compositions. Preferred areas of application for the dispersion powder compositions are leveling compounds, and particularly preferred leveling compounds are self-leveling trowel-applied flooring compounds and screeds.

Surprisingly, with the invention finely divided, polyvinyl alcohol-stabilized (meth)acrylic ester polymers are obtainable which are storage stable in the form of aqueous dispersions, redispersible powders or corresponding aqueous redispersions. Advantageously, commonly used, unmodified polyvinyl alcohols can be used for this, meaning that the property profile of use products is not interfered with as a result. The (meth)acrylic ester polymers can be prepared by established methods. All of this is also advantageous in economic terms.

In addition, the (meth)acrylic ester polymers according to the invention in applications lead to advantageous mechanical properties, such as for example tensile bond strength, and in paint applications lead to high opacity, color density and in particular high wet abrasion resistance.

The examples which follow serve to further illustrate the invention:

### PREPARATION OF THE POLYMER DISPERSIONS

### EXAMPLE 1 (EX. 1)

A polymerization reactor with a volume of 3 liters was initially charged with the following components:

330 g of water, 132 g of a 20% aqueous solution of a partially hydrolyzed polyvinyl alcohol (degree of hydrolysis: 88 mol %; Hoppler viscosity of 4 mPas (determined according to Hoppler in accordance with DIN 53015, 20° C., 4% aqueous solution)) and 0.6 g of a 1% aqueous iron ammonium sulfate solution.

The reactor was provided with a nitrogen protective gas atmosphere. 197 g of vinyl laurate were added and the mixture was heated to 70° C.

The polymerization was initiated by adding 5% by weight aqueous tert-butyl hydroperoxide solution (TBHP) at a rate of 12 g/h and adding 5% by weight aqueous ascorbic acid solution at a rate of 12 g/h.

After 10 min, the metered monomer addition was started, consisting of 592 g of butyl acrylate and 527 g of methyl methacrylate at a rate of 280 g/h (duration 4 h). At the same time, an aqueous metered addition was started, consisting of 557 g of water and 559 g of a 20% by weight solution of a partially hydrolyzed polyvinyl alcohol (degree of hydrolysis: 88 mol %; Hoppler viscosity: 4 mPas) at a rate of 280 g/h (duration 4 h). The polymerization was continued for a further 1 h after the metered monomer addition had ended.

After the dispersion had cooled, postpolymerization was effected on addition of 6.5 g of a 5% by weight aqueous TBHP solution and 6.5 g of a 5% by weight aqueous ascorbic acid solution. The properties of the polymer dispersion obtained in this way are summarized in table 1. The properties were determined as indicated further above in the general description.

### EXAMPLES 2 TO 6 AND COMPARATIVE EXAMPLE 7 (EX. 2-6, CEX. 7)

The polymer dispersions of Ex. 2-6 and CEx. 7 were prepared as described for example 1 with the difference that the monomers indicated in table 2 were used.

The properties of the polymer dispersions obtained in this way are summarized in table 1. The properties were determined as indicated further above in the general description or can be determined in a conventional manner.

TABLE 1
Properties of the polymer dispersions of examples
1 to 6 and comparative example 7:

| | Solids | | Brookfield | Particle size distribution | | | |
|---|---|---|---|---|---|---|---|
| | content | | viscosity* | Dw | Dn | | Tg |
| | [%] | pH | [mPas] | [nm] | [nm] | Dw/Dn | [° C.] |
| Ex. 1 | 46.2 | 3.9 | 696 | 393 | 225 | 1.75 | −5.0 |
| Ex. 2 | 43.2 | 4 | 118 | 780 | 393 | 1.98 | −3.4 |
| Ex. 3 | 44.2 | 3.9 | 335 | 390 | 205 | 1.90 | −4.5 |
| Ex. 4 | 46.7 | 4.1 | 1320 | 297 | 205 | 1.45 | −5.6 |
| Ex. 5 | 46.9 | 4.3 | 410 | 431 | 271 | 1.59 | −9.9 |
| Ex. 6 | 46.2 | 4 | 212 | 770 | 358 | 2.15 | −23.5 |
| CEx. 7 | 47.7 | 4.1 | 2245 | 1748 | 290 | 6.03 | 0 |

*Brookfield viscosity: determined at 20 revolutions and 23° C.

TABLE 2
Monomer composition of the polymers of examples 1 to 6 and comparative example 7:

| | Vinyl | Butyl | Methyl meth- | Vinyltri- | Glycidyl meth- |
|---|---|---|---|---|---|
| | laurate | acrylate | acrylate | ethoxysilane | acrylate |
| | [parts by wt.] | [parts by wt.] | [parts by wt.] | [parts by wt.] | [parts by wt.] |
| Ex. 1 | 15 | 45 | 40 | | |
| Ex. 2 | 10 | 50 | 40 | | |
| Ex. 3 | 15 | 45 | 40 | 0.8 | 0.8 |
| Ex. 4 | 15 | 45 | 40 | 0.8 | 1.6 |
| Ex. 5 | 15 | 50 | 35 | | |
| Ex. 6 | 15 | 60 | 25 | | |
| CEx. 7 | | 55 | 45 | | |

Preparation of the Dispersion Powder Compositions P1 to P6 and CP7:

The polymer dispersions from the (comparative) examples 1 to 7 were each dried, with addition of 2.0% weight, based on the polymer content of the dispersion (solid/solid), of a partially hydrolyzed polyvinyl alcohol (degree of hydrolysis: 88 mol %; Hoppler viscosity: 4 mPas in 4% aqueous solution)) and 6.0% by weight, based on the polymer content of the dispersion (solid/solid), of a partially hydrolyzed polyvinyl alcohol (degree of hydrolysis: 88 mol %; Hoppler viscosity: 13 mPas in 4% aqueous solution)), by spray drying in a manner conventional per se, at an entry temperature of 130° C. and an exit temperature of 80° C., to obtain redispersible powders. The powders were stabilized by addition of 4% by weight of kaolin and 16% by weight of calcium carbonate as anticaking agent.

In all of (comparative) examples 1 to 7, free-flowing, stable dispersion powders were obtained.

Determination of the Properties of the Dispersion Powder Compositions P1 to P6 and CP7:

Determination of the Blocking Resistance (BR):

For determining the blocking resistance, the powder under test was filled into an iron tube with a screw thread and was then loaded with a metal ram. It was stored under loading in a drying cabinet at 50° C. for 16 hours. After cooling to room temperature, the powder was removed from the tube and the blocking stability was determined qualitatively by crushing the powder. The results of the testing are listed in table 3.

The blocking stability was classified as follows:

1=very good blocking stability
2=good blocking stability
3=satisfactory blocking stability
4=not blocking-stable, powder no longer free-flowing after crushing.

Determination of the Sedimentation Behavior (TS):

The sedimentation behavior of redispersions serves as a measure of the redispersibility of redispersible powders. The powder under test was redispersed at a concentration of 50% by weight in water through application of strong shear forces.

The sedimentation behavior was then determined on diluted redispersions (0.5% solids content), and to this end 100 ml of this dispersion was filled into a graduated tube and the height of the sedimented solid was measured. The values are reported in mm of sedimentation after 1 hour and after 24 hours. Values of greater than 7 indicate a highly unsatisfactory redispersion of the powder. The results of the testing are listed in table 3.

TABLE 3
Dispersion powder compositions of examples
1 to 6 and comparative example 7:

Powder properties

| | Dispersion | Powder | TS (1 h) | TS (24 h) | BR |
|---|---|---|---|---|---|
| Ex. 1 | D1 | P1 | 0.3 | 0.6 | 2 |
| Ex. 2 | D2 | P2 | 0.2 | 0.6 | 2-3 |
| Ex. 3 | D3 | P3 | 2.8 | 4.2 | 2-3 |
| Ex. 4 | D4 | P4 | 3.3 | 5.1 | 2-3 |
| Ex. 5 | D5 | P5 | 0.2 | 0.6 | 2-3 |
| Ex. 6 | D6 | P6 | 0.3 | 0.8 | 2-3 |
| CEx. 7 | CD7 | CP7 | 3.9 | 7.8 | 5 |

Performance Testing of the Dispersion Powder Compositions:

Tile Adhesive:

The dispersion powder compositions were tested for their suitability for the adhesive bonding of ceramic tiles. Dry mortars of the following composition were prepared:

420 parts Milke Premium CEM I 52.5 R cement,
446 parts quartz sand,
80 parts calcium carbonate,
4 parts Tylose MB60000 (thickener),
10 parts calcium formate (accelerator),
40 parts dispersion powder composition as indicated in table 4.

The tile adhesive mortar was mixed with 34 g of water per 100 g of dry mortar.

The tiles were laid with the tile adhesive in the conventional manner.

Testing in accordance with DIN EN 12 004 (test standard EN 1348) gave the test results listed in table 4.

TABLE 4
Test results of the tile adhesive:

| | Tensile bond strength test [N/mm²] | | | | |
|---|---|---|---|---|---|
| Powder | Standard climate | Water | Heat | FT | Open time 30′ |
| P1 | 1.28 | 0.97 | 1.12 | 1.25 | 0.81 |
| P2 | 1.31 | 1.02 | 1.19 | 1.28 | 0.85 |
| P3 | 1.33 | 1.12 | 1.34 | 1.26 | 0.76 |
| P4 | 1.35 | 1.21 | 1.32 | 1.38 | 0.69 |
| P5 | 1.29 | 1.14 | 1.27 | 1.31 | 0.78 |
| P6 | 1.19 | 1.01 | 1.21 | 1.23 | 0.84 |
| CP7 | 1.18 | 0.87 | 1.08 | 1.19 | 0.42 |

Compared to the tile adhesive with the comparative dispersion powder composition CP7, the tile adhesives with the dispersion powder compositions P1 to P6 of the invention exhibited improved tensile bond strengths, in particular improved wet strengths, freeze-thaw resistance (FT) and even after thermal stress.

Sealing Slurry:

The dispersion powder compositions P3 and P4 and also CP7 were also tested for tensile bond strength in flexible sealing slurries.

The sealing slurries were based on the formulation of table 5 and were prepared and applied in the conventional manner.

The testing of the tensile bond strength of the sealing slurries after storage in a standard climate and after storage in water was carried out in accordance with EN 14891. The test results are given in table 6.

TABLE 5
Formulation of the sealing slurry:

| | | |
|---|---|---|
| Milke Premium CEM I 52.5 R | 24.00 | g |
| Ternal RG | 24.00 | g |
| F36 quartz sand | 54.00 | g |
| BCS 413 quartz sand | 30.00 | g |
| Poraver (0.1-0.3 mm) | 6.00 | g |
| Acrylate thickener | 0.40 | g |
| Retarder (polyphosphate) | 0.70 | g |
| Lithium carbonate (accelerator) | 0.06 | g |
| P801 | 0.84 | g |
| Polymer powder | 60.00 | g |
| Total | 200.00 | g |
| Water | 54 | g |

TABLE 6
Tensile bond strengths of the sealing slurry:

| Powder | Standard climate | Water |
|---|---|---|
| P3 | 3.17 | 1.08 |
| P4 | 3.06 | 1.03 |
| CP7 | 1.98 | 0.78 |

The tensile bond strength of the sealing slurries can be improved by the use of the dispersion powder compositions of the invention.

Emulsion Paints:

The dispersion powder compositions were tested for their suitability for use in emulsion paints. The emulsion paints were based on the formulation of table 7 and were prepared in the conventional manner and tested as described below. The test results are summarized in table 8.

TABLE 7
Formulation of the emulsion paints:

| Formulation constituent | Mass [g] |
|---|---|
| Dispersion powder | 187.9 |
| TiO₂ pigment (Kronos 2190) | 62.6 |
| Thickener (Tylose MH 30.000 yp2) | 0.9 |
| Plasticizer (1,6-hexanediol) | 9.4 |
| CaCO₃ filler (Omyacarb 5 GU) | 197.9 |
| CaCO₃ filler (Omyacarb 2 GU) | 171.6 |
| Portland cement (Dyckerhoff white) | 4.1 |
| Lime (Wallhalla premium lime hydrate) | 1.8 |
| Cellulose fiber (Arbocel BE 600-30 PU) | 47.4 |
| Dispersing agent (Calgon N) | 3.1 |
| Sum total of solid components | 686.7 |
| Water | 313.3 |
| Total | 1000.0 |

Test Methods:

Testing of the Scrub Resistance SR (Wet Abrasion Resistance) of the Emulsion Paints:

To determine the wet abrasion resistance, the emulsion paints prepared from the powder paints were each tested using the nonwoven pad method in accordance with ISO 11998.

The emulsion paint was in each case applied to a Leneta film (PVC film) using an applicator at a layer thickness of 300 μm (wet).

This was followed by storage for 72 hours in a standard climate (DIN 50014, 23° C. and 50% relative air humidity), then for 24 hours at 50° C. and finally for 24 hours in a standard climate. A dry layer thickness of ca. 200 μm resulted.

Then three test strips each measuring 2.5 cm×7.5 cm were cut out and then weighed.

The scrub test was carried out for 200 cycles and then weighing was performed again. The paint erosion in μm was then calculated from the color density of the scrubbed area and the loss of mass of the paint film.

An average of three measurements was determined in each case.

The scrub resistance after 200 cycles is rated in classes:

Class 1 with abrasion of less than 5 μm,
Class 2 with abrasion of between 5 μm and less than 20 μm,
Class 3 with abrasion of between 20 μm and less than 70 μm.

Measurement of the BF100 Brookfield Viscosities of the Emulsion Paints:

The Brookfield viscosity of the emulsion paints prepared with the powder paint compositions was measured in each case with a Brookfield viscometer BF 35, after heating to 23° C., using the spindle specified in the operating instructions, at 100 revolutions per minute (BF100). The viscosity is stated in mPas in each case.

Determination of the Opacity of the Emulsion Paints:

The opacity was determined using the method in accordance with DIN EN 13300 described in the “Guideline for determining the covering capacity” of the Association of the German Paint Industry, July 2002 edition.

The emulsion paints were applied using an automatic film applicator with a knife coater having a gap height of 150 μm and 225 μm, each on black-and-white contrast cards (type 3H from Lenetta) with a tristimulus value Y over black of 7 or less and a tristimulus value Y over white of 80 to 90.

The contrast cards coated in this way were dried for 24 hours at 23° C. and 50% relative air humidity and then weighed.

The coverage in m²/l was calculated from the application amount in g/m² and the color density. The tristimulus values Y (color standards) were measured over the black and the white base using a colorimeter (Elrepho 450X from Datacolor) and the “contrast ratio” in “%” was calculated.

The values for the contrast ratio determined in this way were plotted on a graph against the corresponding yield (m²/l). By interpolation, the coverage C was determined at 7 m²/l at a contrast ratio of 98%.

The higher the coverage C, the better the opacity.

TABLE 8
Test results of the emulsion paints:

| | BF100 | | | Wet abrasion | |
|---|---|---|---|---|---|
| | viscosity | | | resistance | |
| Powder | [mPas] | pH | Color density | [μm] | Opacity |
| P1 | 6820 | 8.3 | 1.195 | 24.7 | 95.3 |
| P2 | 6350 | 8.6 | 1.275 | 30.3 | 96 |
| P3 | 7170 | 8.4 | 1.222 | 21.3 | 96.1 |
| P4 | 7840 | 8.4 | 1.21 | 33.7 | 96.9 |
| P5 | 6060 | 8.3 | 1.168 | 34.5 | 95.8 |
| P6 | 5710 | 8.3 | 1.106 | 35.1 | 96 |
| CP7 | 5890 | 8.5 | 1.241 | 39.9 | 96.1 |

The wet abrasion resistance of emulsion paints could be considerably raised with the powders of the invention. The other properties satisfy the requirements on emulsion paints.

1-14. (canceled)

15. Polyvinyl alcohol-stabilized (meth)acrylic ester polymers, comprising:
wherein the polyvinyl alcohol-stabilized (meth)acrylic ester polymers have particle sizes Dw of from 100 to 900 nm in the form of aqueous dispersions or water-redispersible powders, wherein the (meth)acrylic ester polymers are based on
(a) 1% to 30% by weight of one or more vinyl esters of carboxylic acids having 5 to 15 carbon atoms,
(b) 20% to 80% by weight of one or more (meth)acrylic esters, wherein the homopolymer of which has a glass transition temperature Tg of ≤20° C.,
(c) 10% to 70% by weight of one or more (meth)acrylic esters, wherein the homopolymer of which has a glass transition temperature Tg of ≥50° C., and
(d) optionally one or more further ethylenically unsaturated monomers,
wherein the percentages by weight are based on the total weight of the (meth)acrylic ester polymers.

16. The polyvinyl alcohol-stabilized (meth)acrylic ester polymers of claim 15, wherein the one or more (meth)acrylic esters (b) are selected from the group comprising n-butyl acrylate, n-hexyl acrylate, n-hexyl methacrylate, 2-ethylhexyl acrylate, 2-ethylhexyl methacrylate, lauryl acrylate and stearyl acrylate.

17. The polyvinyl alcohol-stabilized (meth)acrylic ester polymers of claim 15, wherein the one or more (meth)acrylic esters (b) are selected from the group comprising methyl methacrylate, tert-butyl methacrylate and tert-butyl acrylate.

18. The polyvinyl alcohol-stabilized (meth)acrylic ester polymers of claim 15, wherein the (meth)acrylic ester polymers are based to an extent of 50% to 99% by weight on (meth)acrylic esters (b) and (meth)acrylic esters (c), based on the total weight of the (meth)acrylic ester polymers.

19. The polyvinyl alcohol-stabilized (meth)acrylic ester polymers of claim 15, wherein the (meth)acrylic ester polymers are additionally based on one or more ethylenically unsaturated silanes (d) of the general formula
R¹SiR²₀₋₂(OR³)₁₋₃,
wherein R² is a C₁ to C₃ alkyl radical;
wherein C₁ to C₃ alkoxy radical or halogen;
wherein R¹ denotes CH₂═CR⁴—(CH₂)₀₋₁ or CH₂═CR⁴CO₂(CH₂)₁₋₃ with R⁴ as a carbon radical having 1 to 10 carbon atoms;
wherein R³ is an unbranched or branched; and
optionally substituted alkyl radical having 1 to 12 carbon atoms.

20. The polyvinyl alcohol-stabilized (meth)acrylic ester polymers of claim 15, wherein the (meth)acrylic ester polymers are additionally based on glycidyl methacrylate or glycidyl acrylate.

21. The polyvinyl alcohol-stabilized (meth)acrylic ester polymers of claim 15, wherein the (meth)acrylic ester polymers are based to an extent of 0 to 20% by weight, based on the total weight of the (meth)acrylic ester polymers, on one or more ethylenically unsaturated monomers (f) selected from the group comprising vinyl esters of carboxylic acids having 2 to 4 carbon atoms, olefins, dienes, vinylaromatics and vinyl halides.

22. The polyvinyl alcohol-stabilized (meth)acrylic ester polymers of claim 15, wherein the (meth)acrylic ester polymers contain no ethylene units and/or no units of a vinyl ester of a carboxylic acid having 2 to 4 carbon atoms.

23. The polyvinyl alcohol-stabilized (meth)acrylic ester polymers of claim 15, wherein the polyvinyl alcohols are composed exclusively of vinyl alcohol and vinyl acetate units.

24. The polyvinyl alcohol-stabilized (meth)acrylic ester polymers of claim 15, wherein no emulsifiers are present.

25. The polyvinyl alcohol-stabilized (meth)acrylic ester polymers of claim 15, wherein the (meth)acrylic ester polymers have a polydispersity PD of ≤3.

26. The polyvinyl alcohol-stabilized (meth)acrylic ester polymers of claim 15, wherein the polyvinyl alcohol-stabilized (meth)acrylic ester polymers are used in leveling compounds, renders, spackling compounds, jointing mortars, tile adhesives, integrated thermal insulation adhesives, sealing slurries, thermal insulation composite systems or paints.

27. A process for preparing polyvinyl alcohol-stabilized (meth)acrylic ester polymers, comprising:
providing polyvinyl alcohol-stabilized (meth)acrylic ester polymers having a particle sizes Dw of from 100 to 900 nm in the form of aqueous dispersions or water-redispersible powders by free-radically initiated emulsion polymerization of ethylenically unsaturated monomers in the presence of polyvinyl alcohol in aqueous medium and optionally subsequent drying, wherein
(a) 1% to 30% by weight of one or more vinyl esters of carboxylic acids having 5 to 15 carbon atoms,
(b) 20% to 80% by weight of one or more (meth)acrylic esters, the homopolymer of which has a glass transition temperature Tg of ≤20° C.,
(c) 10% to 70% by weight of one or more (meth)acrylic esters, the homopolymer of which has a glass transition temperature Tg of ≥50° C., and
(d) optionally one or more further ethylenically unsaturated monomers are polymerized, and
where the percentages by weight are based on the total weight of the (meth)acrylic ester polymers.

28. The process of claim 27, wherein the vinyl esters (a) are initially charged in part or in full and the (meth)acrylic esters (b) and/or the (meth)acrylic esters (c) and optionally the further ethylenically unsaturated monomers (d) are metered in in full or in part.
